(19) United States
(12) Patent Application Publication
(10) Pub. No.: US 2014/0330546 A1
(43) Pub. Date: Nov. 6, 2014

(54) Method for Urodynamics Testing and Analysis

(71) Applicants: Huinan Deng, Guangzhou (CN); Hu Chen, Jiangmen (CN)

(72) Inventors: Huinan Deng, Guangzhou (CN); Hu Chen, Jiangmen (CN); Bo Song, Chongqing (CN); Yi Chen, Jiangmen (CN)

(73) Assignee: Huinan Deng; Hu Chen

(21) Appl. No.: 14/333,535

(22) Filed: Jul. 17, 2014

Related U.S. Application Data
(63) Continuation-in-part of application No. 13/496,841, filed on Mar. 16, 2012, now abandoned.

(51) Int. Cl. G06F 19/12; G06F 17/50

(52) U.S. Cl. CPC G06F 19/12; G06F 17/5009
USPC 703/2

(57) ABSTRACT

This invention relates to a noninvasive method for urodynamics testing and analysis, comprising: modeling a bladder before a releasing of the urine as a topological sphere, modeling a circle formed by cutting the topological sphere through its center as an elastic element, determining a functional relation between a length L of the elastic element and a urine volume a within the bladder: L=F(a), determining a functional relation between a length contraction ΔL of the elastic element and both of a urinary flow rate Q and the urine volume a within the bladder: ΔL=ξ(Q,a), determining a functional relation between a contraction velocity ν of the elastic element and the length contraction ΔL of the elastic element: ν=ΔL, calculating a value of an index DC for assessing a bladder contractility to determine the bladder contractility of the subject.

### CROSS-REFERENCE TO RELATED APPLICATIONS

The present application is a Continuation-in-part application of U.S. patent application Ser. No. 13/496,841 filed on Mar. 16, 2012, which is a national stage application of PCT application No. PCT/CN2010/076835 filed on Sep. 13, 2010, which in turn claims the benefit of Chinese patent application No. 200910190862.4 filed on Sep. 16, 2009, the contents of which are hereby incorporated by reference.

### FIELD OF THE INVENTION

The present invention relates to a noninvasive method for urodynamics testing and analysis, and especially to a noninvasive method for determine a bladder contractility of a subject and a noninvasive method for diagnosing a bladder outflow obstruction in male subject.

### BACKGROUND OF THE INVENTION

Urodynamics is a branch of interdisciplinary knowledge of modern medicine, biofluid mechanics and biorheology, which is usually used for the basic research, diagnosis, treatment and assessment of urinary tract obstructions, urinary incontinence, urinary tract dysfunction and other diseases, and is closely related with urology, gynaecology, obstetrics, pediatrics, endocrinology, neurology and anorectum.

At present, directly-measured parameters in conventional urodynamics are intravesical pressure, abdominal pressure, rectal pressure, urinary flow rate and urine volume within the bladder. Detrusor pressure, which is also known as true bladder pressure, will be determined by subtraction (i.e., the intravesical pressure minus the abdominal pressure).

The most commonly used method for urodynamic testing is invasive and comprises the following steps of: measuring the intravesical pressure by using a transurethral pressure catheter, at the same time measuring the urinary flow rate, measuring the abdominal pressure by using abdominal electrodes, measuring a pressure distribution of each section of an urethra by using a pressure catheter with flow-maintained perfusion and constant withdrawing speed, and utilizing an Abrams-Griffiths nomogram (AG nomogram) and/or a Detrusor Pressure-Flow Rate nomogram (P/Q nomogram) approved by the International Continence Society to diagnose urological diseases, for example, bladder outlet obstruction (BOO).

In general, the P/Q nomogram will identify three voiding patterns: (1) obstructed (high detrusor pressure and low flow rate); (2) unobstructed (low detrusor pressure and high flow rate); and (3) equivocal (low detrusor pressure and low flow rate). Specifically, the diagnosis of BOO is currently made by plotting the detrusor pressure at maximum flow (p_{det}Qₘₐₓ) and maximum flow rate (Qₘₐₓ) of a subject on the nomogram approved by the International Continence Society. This plot will categorize the void as obstructed, equivocal or unobstructed. Though good agreement was found between diagnosis results obtained from this invasive investigation and real conditions of BOO in the subject, false-positive results may be obtained with this invasive investigation, because the measuring processes of the invasive investigation are performed under non-physiological conditions for the subject. Besides, this invasive investigation adds to patients' pain and increases infection risk. Therefore, noninvasive methods for accurately diagnosing BOO are needed.

Impaired bladder contractility is common in older adults. Bladder contractility is an inherent characteristic of detrusor muscle, which is influenced by cytoplasmic calcium concentration, ATP enzyme activity, intracellular protein and its isoforms expression level. The bladder contractility relates to contractile strength and contractile duration. The muscle physiology discovered that a stronger contractility will cause a faster contraction. In addition, if good bladder contractility is accompanied with bad flow rate in a subject, the subject probably suffers from BOO, since a high afterload (resistance) might exist.

Generally speaking, maximum isovolumetric detrusor pressure is now believed to be the gold standard for assessing the bladder contractility, however, the value of maximum isovolumetric detrusor pressure is based on the intravesical pressure, which is obtained by invasive measuring such as by using a transurethral pressure catheter. Though some noninvasive methods have been developed for measuring the intravesical pressure, for example, by detecting the change in detrusor muscle hemoglobin through infrared, the use of these methods are expensive and clinical benefits of these methods are still pending. Therefore, another index for assessing the bladder contractility, which is calculated without using invasive techniques, will be very useful in diagnosing the possibility of a detrusor weakness.

### SUMMARY OF THE INVENTION

It is a primary aim of the present invention to provide a novel noninvasive method for urodynamics testing and analysis.

In one embodiment of the present invention, a noninvasive method for urodynamics testing and analysis comprises: modeling a bladder before a releasing of the urine as a topological sphere, modeling a circle formed by cutting the topological sphere through its center as an elastic element, determining a functional relation between a length L of the elastic element and a urine volume a within the bladder: L=F(a), determining a functional relation between a length contraction ΔL of the elastic element and both of a urinary flow rate Q and the urine volume a within the bladder: ΔL=ξ(Q,a), determining a functional relation between a contraction velocity ν of the elastic element and the length contraction ΔL of the elastic element: ν=ΔL, calculating a value of an index DC for assessing a bladder contractility according to the following formula:

$$DC = \frac{{\sum }_{i = 1}^{n} ( Δ {t}_{i} - \overline{t} ) ( Δ {L}_{i} - Δ \overline{L} )}{{\sum }_{i = 1}^{n} {( Δ {t}_{i} - \overline{t} )}^{2}}$$

wherein, n=5, tᵢ=time point i, Δtᵢ=tᵢ−tᵢ₋₁, t̅=mean time=(t₁+t₂+ . . . +tₙ)/n, ΔLᵢ=a length contraction ΔL of the elastic element at a time point i, and ΔLᵢ=Lᵢ₋₁−Lᵢ, Δ L̅=mean length contraction ΔL of the elastic element=(ΔL₁+ΔL₂+ . . . +ΔLₙ)/n, comparing the value of DC of a subject with normal values of DC to determine the bladder contractility of the subject, determining that the bladder contractility of the subject is impaired and further investigations are required, if the value of DC of the subject is lower than the normal values, and determining that the subject is diagnosed to have a normal bladder contractility, if the value of DC of the subject is within the range of the normal values. In one embodiment of the present invention, the value of DC of the subject is compared with 1, if the value of DC of the subject is lower than 1, the bladder contractility of the subject is impaired; if the value of DC of the subject is greater or equal to 1, the bladder contractility of the subject is normal.

In another embodiment of the present invention, a noninvasive method for checking if there is a significant involvement of an abdominal pressure at a time point i during the releasing of the urine comprises: calculating a value of an index RDCVV at a time point i according to the following formula:

$$RDCVV = \frac{Δ {L}_{i}}{Δ {L}_{i - 1}} - 1$$

wherein ΔLᵢ=the length contraction ΔL of the elastic element at a time point i, ΔLᵢ₋₁=the length contraction ΔL of the elastic element at a time point i−1, and ΔLᵢ=Lᵢ₋₁−Lᵢ, comparing an absolute value |RDCVV| of the value of RDCVV with 0.2, determining that the involvement of the abdominal pressure is significant at the time point i if the value of |RDCVV| is greater than 0.2, except for the first three seconds and the last three seconds during the releasing of the urine, and determining that the involvement of the abdominal pressure is insignificant at the time point i if the value of |RDCVV| is lower than 0.2, except for the first three seconds and the last three seconds during the releasing of the urine.

In another embodiment of the present invention, a noninvasive method for diagnosing a bladder outflow obstruction in male comprises: calculating values of DC and a maximum flow rate from a group of samples who have undergone cystometry to diagnose the bladder outflow obstruction, obtaining the values of DC and the maximum flow rate for each of these samples, drawing a scatter plot according to the values of DC and the maximum flow rate, establishing a DC-Maximum Flow Rate nomogram as a standard according to results of the cystometry, with the DC-Maximum Flow Rate nomogram categorizing a void as obstructed, equivocal or unobstructed, and diagnosing the bladder outflow obstruction of a subject by plotting his value of DC at maximum flow rate on the DC-Maximum Flow Rate nomogram. Preferably, the group of samples and the subject all have a an initial urine volume within the bladder greater than 150 ml, DC more than 1 and absolute values of RDCVV less than 0.2 throughout the releasing of the urine except for the first three seconds and last three seconds. More preferably, the initial urine volume within the bladder is greater than 300 ml.

The technical solutions of the present invention has the following advantages. By combining noninvasive investigations and mathematical analysis, the condition of detrusor contractility of a subject can be determined. During the investigations, patients' pain and infection can be avoided by using the methods of the present invention, while those pain and infection usually occurred in traditional invasive urodynamics investigations. Besides, during the mathematical analysis, all analysis processes can be performed automatically with the aid of a computer, the results thereby are clear and convenient for clinical memory and use. Therefore, an apparatus applied with the methods of the present invention for urodynamics testing and analysis will have a simple structure and will be convenient for maintenance, thereby reducing the hospitalization costs.

### BRIEF DESCRIPTION OF THE DRAWINGS

For a more complete understanding of the present invention and the advantages thereof, reference should be made to the following detailed description taken in connection with the accompanying drawings in which:

FIG. 1 is a schematic diagram of the urine in a bladder.

FIG. 2 is a schematic diagram of a topological sphere and an elastic element, FIG. 2 also shows a length L of the elastic element at time point 0, 1 and i, and shows a length contraction ΔL of the elastic element at time point 1 and i.

FIG. 3 (A) is a RDCVV-Time plot, which shows values of RDCVV in a 32-year-old male with a normal voiding of urine. FIG. 3 (B) is a RDCVV-Time plot, which shows values of RDCVV during a voiding in a 23-year-old male who suffered from detrusor-sphincter dyssynergia.

FIG. 4 shows a frequency histogram of values of DC in a group of male samples with a sample size of 384. Among these 384 samples, 367 samples having DC value ≧1 were determined to have a normal bladder contractility with traditional invasive measuring methods, and 17 samples having DC value <1 were diagnosed to have an impaired bladder contractility with the traditional invasive measuring methods.

FIG. 5 is a scatter plot showing distributions of DCs at Qmax from 233 male samples, who had been classified as 22 unobstructed (Δ), 49 equivocal (□) and 162 obstructed () by using the P/Q nomogram.

FIG. 6 (A) shows boundaries in a C/Q nomogram of the present invention. The C/Q nomogram provides best boundaries dividing data into three regions: an area enclosed by a pentagon indicates “obstructed”, an area enclosed by the quadrilateral indicates “equivocal”, an area colored with grey indicates “unobstructed” (see FIG. 6 (B) for an initial bladder volume of 150-300 ml, and FIG. 6 (C) for an initial bladder volume greater than 300 ml). Referring to FIG. 6 (A)-(C), it was the dotted line nomogram when an initial bladder volume was 150-300 ml, the equivocal and obstructed regions were separated by line AB, with the point A, B (◯) and C (Δ) were set at: A(0, 3), B(13, 15) and C(30, 12). It was the solid line nomogram when an initial bladder volume was greater than 300 ml, the equivocal and obstructed regions were separated by line A′B′, with the point A′, B′ () and C′ (▴) were set at: A′ (0, 5), B′ (9, 15) and C′ (25, 12).

FIG. 7 is a scatter plot showing distributions of DCs at Qmax from 522 male subjects, who had been classified as 88 unobstructed (Δ), 106 equivocal (□) and 328 obstructed () by using the P/Q nomogram.

### DETAILED DESCRIPTION OF ILLUSTRATED EMBODIMENTS

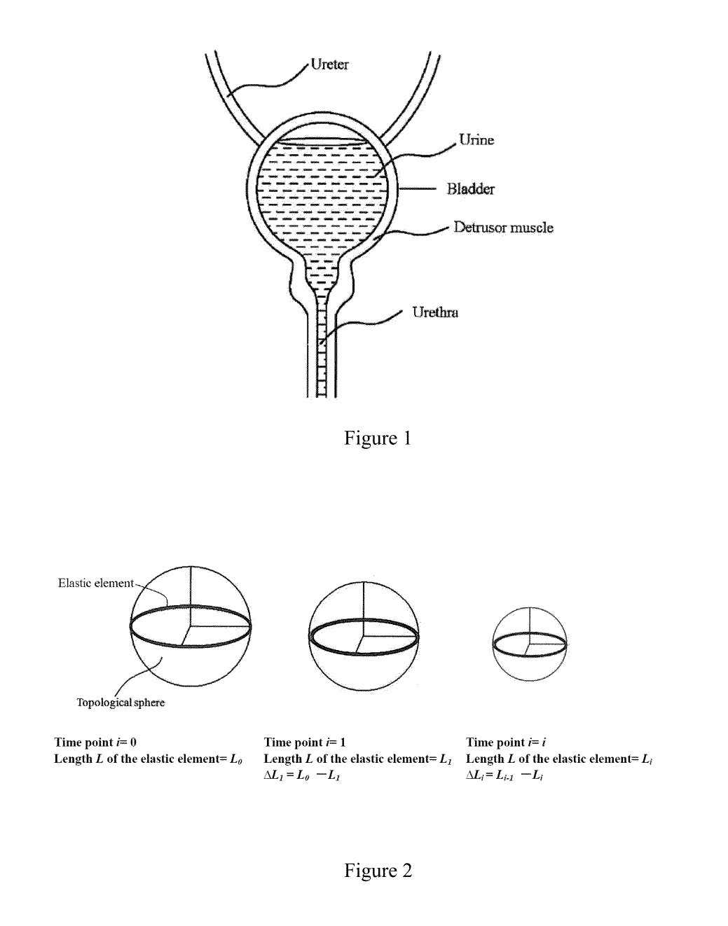

Inspired by a topological mathematical Hill model (T. L. Hill, E. Eisenberg, J. M. (1981) Chalovich Theoretical models for cooperative steady-state ATPase activity of myosin subfragment-1 on regulated actin. Biophys J 35:99-112), the bladder is assumed as a hollow sphere, with a sphere wall having visco-elastic properties but no thickness (see FIG. 1 and FIG. 2). We first cut the sphere through its center to get a circle, assume the circle as a detrusor muscle fiber of the bladder, and then model the circle as an elastic element. Thus, the perimeter of the circle equals a length L of the elastic element.

Let a be a urine volume (ml) within the bladder. Let Q be a urinary flow rate (ml/s). Q is the urine output per second according to the urodynamic theory, therefore, the value of Q at a voiding time point i (tᵢ, second), i.e., Qᵢ, equals a total released urine volume collected from t₀ to tᵢ minus a total released urine volume collected from t₀ to tᵢ₋₁.

Since the volume of a sphere is V=4πr³/3, its radius is r=(3 V/4π)^{1/3}. Notice that the perimeter of a circle is C=2πr and that C=L. We can get the length L of the elastic element L=2πr=2π (3V/4π)^{1/3}=2π (3a/4π)^{1/3} that is,

$$L = 2 * π * \sqrt[3]{\frac{3 a}{4 π}} . \qquad ( Equation 1 )$$

Prior to voiding (t₀), the urine volume a (which can be expressed as a₀ at the time point t₀) is assumed to be known. According to Equation (1), an initial length L₀ of the elastic element is:

L₀=2π(3a₀/4π)^{1/3}.

At the first second (t₁), the urinary flow rate is Q₁, the urine volume is a₁, and a relation among Q₁, a₁ and a₀ is as follows:

a₁=a₀−Q₁.

By using Equation (1) again, at the first second (tᵢ), the length L of the elastic element is L₁ which reads:

L₁=2π[3(a₀−Q₁)/4π]^{1/3}.

Hence, a length contraction ΔL of the elastic element at the first second (t₁) (which can be expressed as ΔL₁ at the time point t₁) is:

$$\begin{matrix}Δ {L}_{1} = {L}_{0} - {L}_{1} \\ = 2 {π ( 3 {a}_{0} / 4 π )}^{1 / 3} - 2 {π [ 3 ( {a}_{0} - {Q}_{1} ) / 4 π ]}^{1 / 3} ,\end{matrix}$$

and a contraction velocity ν of the elastic element at the first second (tᵢ), which can be expressed as ν₁, is ν₁=ΔL₁/1=ΔL₁.

Similarly, at a time point i, the length contraction ΔL of the elastic element can be expressed as ΔLᵢ:

$$\begin{matrix}Δ {L}_{i} = {L}_{i - 1} - {L}_{i} \\ = 2 {π ( 3 {a}_{i - 1} / 4 π )}^{1 / 3} - 2 {π [ 3 ( {a}_{i - 1} - {Q}_{i} ) / 4 π ]}^{1 / 3} ,\end{matrix} \\ that is , \\ Δ {L}_{i} = 2 * π * \sqrt[3]{\frac{3 {a}_{i - 1}}{4 π}} - 2 * π * \sqrt[3]{\frac{3 ( {a}_{i - 1} - {Q}_{i} )}{4 π}} \qquad ( Equation 2 )$$

and the contraction velocity ν of the elastic element is νᵢ=ΔLᵢ/1=ΔLᵢ.

As we know, abdominal pressure can influence urodynamic results. To accurately record detrusor pressure, abdominal pressure is always excluded from the bladder pressure in invasive urodynamic investigations. The inventors of the present invention herein introduce a new parameter, Rate of Detrusor Contraction Velocity Variation (RDCVV), as a convenient, quick, and effective way of judging the involvement of abdominal pressure:

$$RDCVV = \frac{Δ {L}_{i}}{Δ {L}_{i - 1}} - 1. \qquad ( Equation 3 )$$

It can be seen that, the value of RDCVV at a time point i denotes the percentage of an increase or decrease of the contraction velocity between the time point i and a time point i−1. It has been observed that the value of RDCVV can be influenced by the urethra at a start time and an end time of the voiding. The inventors of the present invention have found that if an absolute value |RDCVV| of RDCVV at a time point i is lower than 0.2 during a micturition except for the first three seconds and the last three seconds, it indicates an insignificant involvement of the abdominal pressure at the time point i. On the contrary, if the value of |RDCVV| at a time point i is greater than 0.2 during a micturition except for the first three seconds and the last three seconds, it indicates a significant involvement of the abdominal pressure at the time point i.

As for the topological mathematical model of bladder of the present invention, the length L of the elastic element equals the perimeter of the circle, the value of RDCVV is based on the measured urinary flow rate Q. Therefore, a value of RDCVV greater than 0.2 (or 20%) means that the change in the length of smooth muscle fiber is more than 20% within one second under the restrictions of the chains of sarcomeres and the muscle architecture. By drawing a RDCVV-Time curve, patterns of change in the length of the elastic element will be clearly revealed.

The inventors of the present invention herein also introduce an index, Detrusor Contractility (DC), to assess the bladder contractility without requiring any invasive measuring. The value of DC is calculated by the following formula:

$$DC = \frac{{\sum }_{i = 1}^{n} ( Δ {t}_{i} - \overline{t} ) ( Δ {L}_{i} - Δ \overline{L} )}{{\sum }_{i = 1}^{n} {( Δ {t}_{i} - \overline{t} )}^{2}}$$

wherein,
n=5;
tᵢ=time point i;
Δtᵢ=tᵢ−tᵢ₋₁;
t̅=mean time, and t̅=(t₁+t₂+ . . . +tₙ)/n;
ΔLᵢ=length contraction ΔL of the elastic element at a time point i, and ΔLᵢ=Lᵢ₋₁−Lᵢ;
ΔLᵢ=mean length contraction ΔL of the elastic element=(ΔL₁+ΔL₂+ . . . +ΔLₙ)/n.

It can be seen that, DC is a slope of a Contraction Velocity-Time curve during the first five seconds. In practical use of the value of DC for assessing the bladder contractility according to the present invention, the value of DC from a subject is compared with normal values of DC, wherein the normal values of DC are collected from a group of samples having a healthy bladder, with the number of the samples obeying statistical rules (Methods of medical research-design, measurement and evaluation; Author: Yi Dong and Xiong Hongyan; Southwest China Normal University Press; Aug. 1, 2009). Specifically, if the value of DC in the subject is lower than the normal values, the subject has the possibility of having detrusor weakness and a further inspection might be required, if the value of DC in the subject is within the range of the normal values, the subject is diagnosed to have a normal bladder contractility.

If a good bladder contractility is accompanied with a bad flow rate in a subject, the subject probably suffers from BOO, since a high afterload (resistance) might exist. Hence, a Detrusor Contractility-Flow Rate nomogram is likely to be a promising substitute for P/Q nomogram.

### EXAMPLES

### Example 1

### RDCVV Observed in Subjects

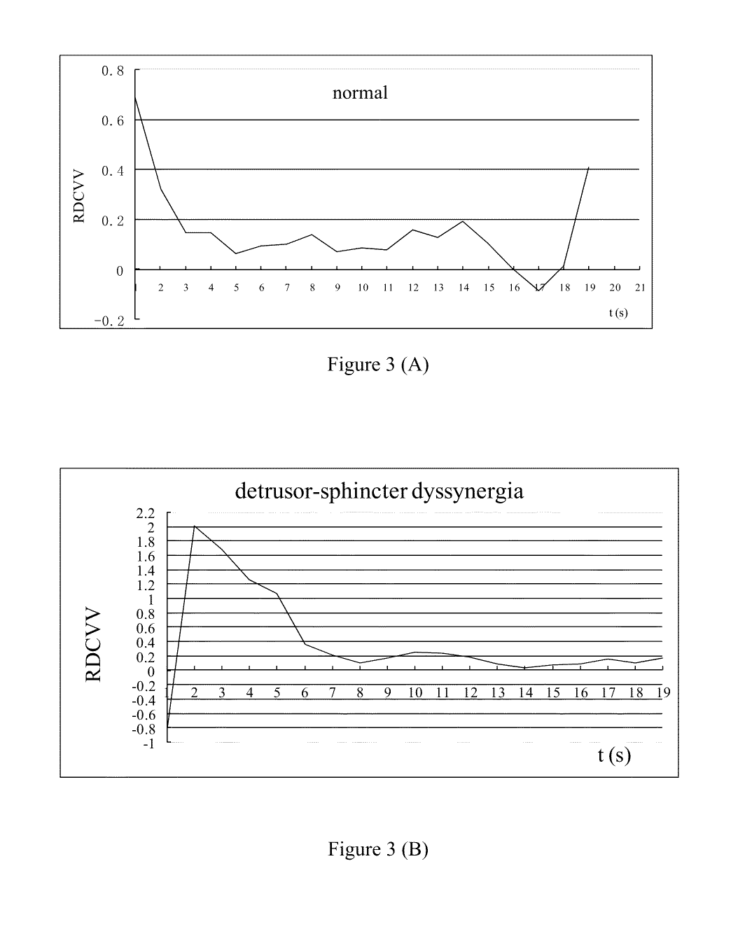

FIG. 3 (A) shows RDCVV in a 32-year-old male with a normal voiding of urine. In the FIG. 3 (A), all calculated values of RDCVV are less than 0.2 throughout the voiding, except for the first three seconds and the last one second, this result is consistent with the result detected by using abdominal electrodes.

FIG. 3 (B) shows RDCVV during a voiding in a 23-year-old male who suffered from detrusor-sphincter dyssynergia. From FIG. 3 (B), we can see that RDCVV is greater than 0.2 from the start of the voiding to the 7 second and approximately 9.5-11.5 seconds, this result is consistent with the result detected by using abdominal electrodes.

### Example 2

### Values of DC Observed in Male Subjects

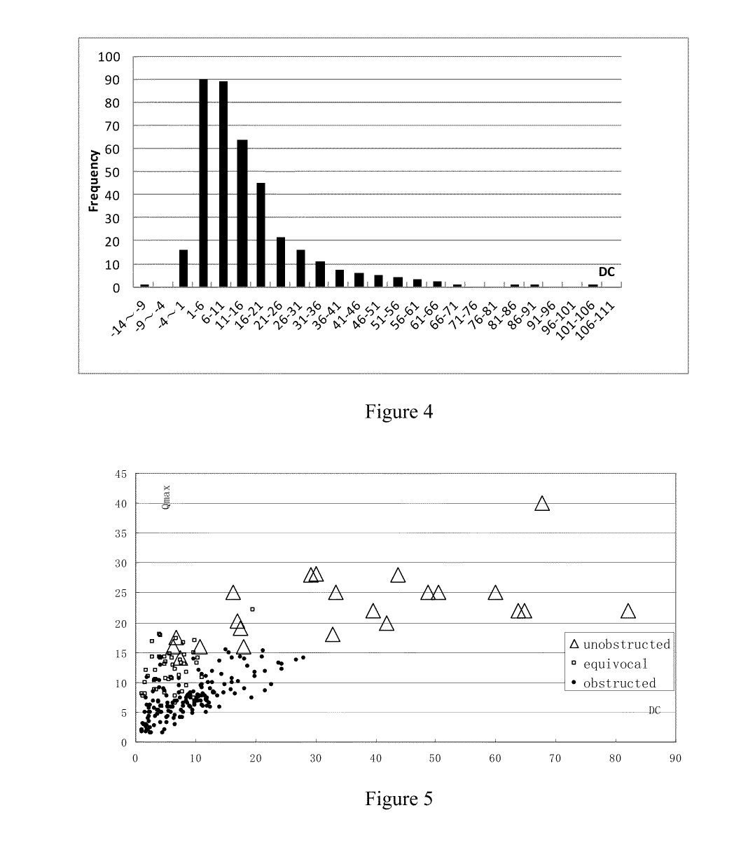

FIG. 4 shows a frequency histogram of values of DC in a group of male samples with a sample size of 384. It can be calculated from the frequency histogram that the value of DC ranges from −12 to 104, the arithmetic mean is 14.67±14.51. Among these 384 samples, 367 samples having DC value ≧1 were determined to have a normal bladder contractility with traditional invasive measuring methods, and 17 samples having DC value <1 were diagnosed to have an impaired bladder contractility with traditional invasive measuring methods. Therefore, we rule that a critical value of DC for assessing the bladder contractility is DC=1, that is to say, if the value of DC in a subject is less than 1, the subject has the possibility of having detrusor weakness and a further inspection might be required, if the value of DC in a subject is within a range of from 1 to 104, the subject is diagnosed to have a normal bladder contractility.

### Example 3

### Clinical Trials to Verify Consistency, Specificity and Sensitivity of Using DC as an Index to Assess the Bladder Contractility as Compared with the Gold Standard

As shown in Table 1, 396 male subjects (age range: 28 to 78 yrs; mean: 57.39 yrs) who had undergone cystometry (the gold standard, which is an invasive urodynamics investigation) to assess the bladder contractility were enrolled in this study. When comparing with the gold standard, a sensitivity of the DC-assessing method of the present invention is Se=9/12=75%, a specificity of the DC-assessing method of the present invention Sp=363/384=94.53%, and a consistency of the DC-assessing method T=372/396=93.94%, therefore, highly accurate results can be obtained by using the DC-assessing method of the present invention.

TABLE 1

Invasive test

| | | Detrusor | Normal | |
|---|---|---|---|---|
| | | Weakness | Detrusor | |
| DC | positive | 9 | 21 | 30 |
| | negative | 3 | 363 | 366 |
| | | 12 | 384 | |

### Example 4

### Establishment of a DC-Maximum Flow Rate Nomogram (C/Q Nomogram)

388 male patients with Lower Urinary Tract Symptoms (age range: 28 to 68 yrs; mean: 55.12 yrs) who had undergone cystometry were enrolled in this study. RDCVV and DC were calculated based on free-flow urinary flow rate.

By calculating Kappa value, sensitivity, specificity, positive and negative predictive value, by drawing ROC curve and then calculating the area under the curve (AUC), the consistency of two diagnostic methods for diagnosing BOO, i.e., the method using the P/Q nomogram vs. the method using C/Q nomogram of the present invention, is evaluated. Evaluation standards are as follows: Kappa=1 showed identical, Kappa ≧0.75 showed excellent consistency, 0.4˜0.75 showed Highly consistent, and Kappa ≦0.4 showed poor consistency. The value of AUC>0.9 indicates that there is a higher accuracy, 0.7˜0.9 indicating that a certain accuracy, 0.5˜0.7 showed a lower accuracy.

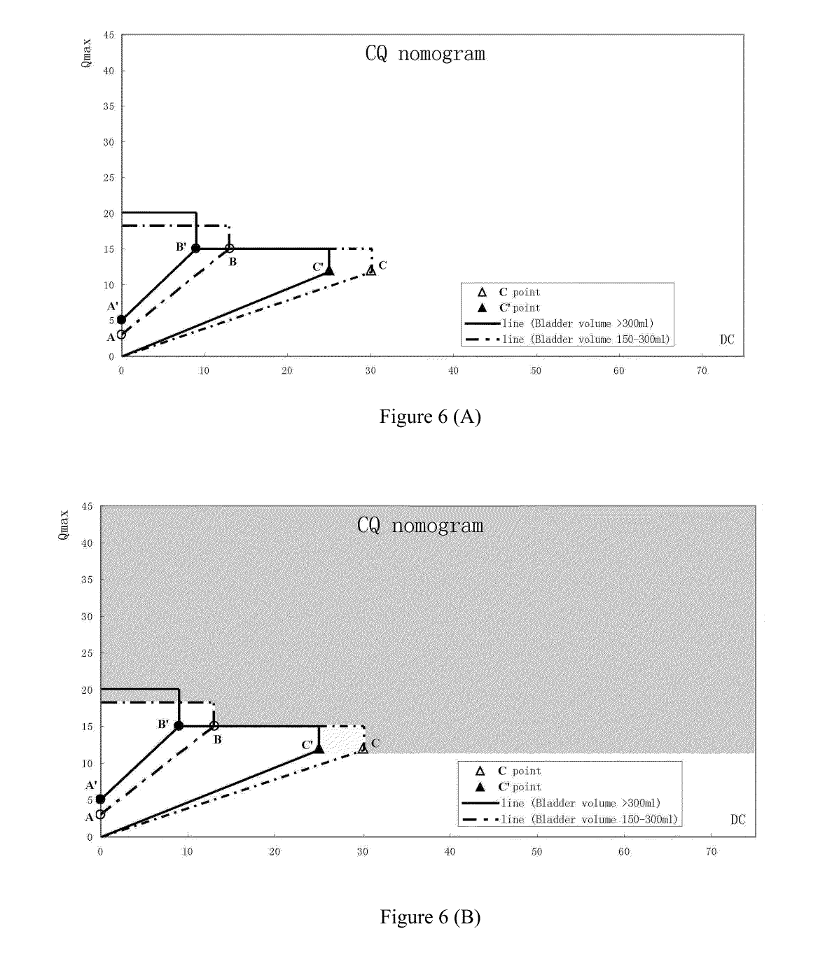

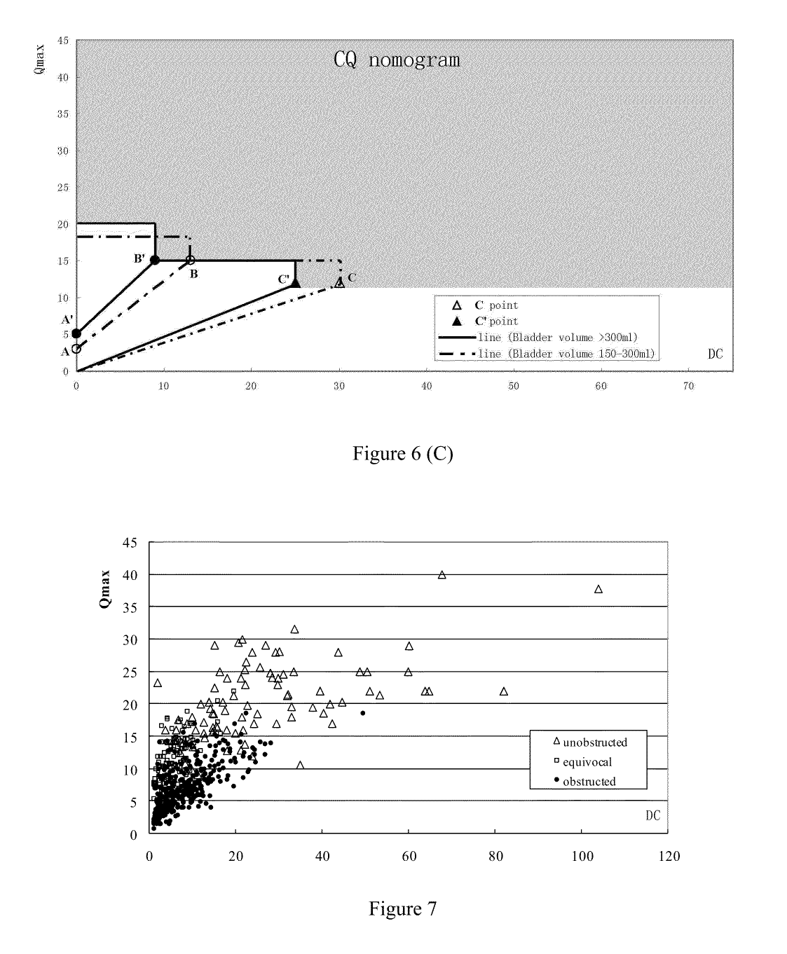

Among the 388 cases, 233 were identified with an initial bladder volume (before voiding) greater than 150 ml, DC more than 1 and an absolute value of RDCVV less than 0.2 throughout the voiding except for the first three seconds and last three seconds. The other 155 cases with the initial bladder volume less than 150 ml, DC less than 1 or the absolute value of RDCVV greater than 0.2 were considered to be unsuitable for the C/Q study. The distribution of these 233 cases (22 unobstructed, 49 equivocal and 162 obstructed) according to their DC values is presented in FIG. 5. Their DCs at Qmax can be plotted in a C/Q nomogram, which was shown in FIG. 6 (A)-(C). Based on the invasive urodynamic P/Q results, the C/Q nomogram with three regions (obstructed, equivocal, and unobstructed) for describing the relationship between the DC and the Qmax can be acquired with Kappa 0.769 (P=0.000), a sensitivity of 0.88, specificity of 0.93, positive predictive value 0.84, negative predictive value 0.85 and AUC 0.91. The equivocal and obstructed regions were separated by line AB (or A′B′), with the point A and B were set at: A(0, 3) and B(13,15) when the bladder volume was 150-300 ml; A′ (0, 5) and B′ (9,15) when the bladder volume was over 300 ml.

### Example 5

### Clinical Trials to Verify the Consistency, Specificity and Sensitivity of the C/Q Nomogram of the Present Invention

We retrospectively analyzed 1,863 male outpatients who underwent urodynamic P/Q analysis in our previous study. Among them, 522 were suitable for both the P/Q and C/Q analyses. 328 cases were confirmed with BOO using the P/Q nomogram, 106 cases were equivocal and 88 were non-BOO. The DC value was calculated. The C/Q nomogram shown in FIGS. 6 (A)-(C) was used for plotting each case. Sensitivity, specificity and Kappa value were determined according to the P/Q study results.

Data from the 522 subjects classified as obstructed, equivocal or unobstructed were used for the subsequent analysis. Scatter plots for DC versus Qmax are shown in FIG. 7. The 328 patients with BOO confirmed by the P/Q nomogram were plotted in the areas of C/Q nomogram areas: 294 were obstructed, 28 were equivocal and 6 were unobstructed. The 106 patients confirmed as equivocal based on the P/Q nomogram were plotted in C/Q nomogram areas: 12 were unobstructed, 82 were equivocal and 12 were obstructed. The 88 patients confirmed as without BOO based on the P/Q nomogram were plotted in C/Q nomogram areas: 69 were unobstructed, 11 were equivocal and 8 were obstructed.

The following verification results were obtained: The Kappa value of the C/Q nomogram was 0.73 (P=0.000), a sensitivity of 0.82, specificity of 0.92, positive predictive value 0.80, negative predictive value 0.86, 0.87 for AUC.

### Discussion.

In the present invention, we established a noninvasive topological mathematical nomogram to diagnose the bladder outflow obstruction (BOO) in male. After calculation, if a subject's RDCVV is less than 0.2 throughout the voiding except for the first three seconds and last three seconds, DC is great than 1 and the urine volume before the voiding is more than 150 ml, his DC value at Qmax can be plotted in our novel C/Q nomogram. The plotted point will reveal his situation as obstructed, equivocal or unobstructed.

Topology is a basic technique that has been applied in physical, biological and chemical research since the 1980s. Using topological technology, a series of parameters can be measured and widely used. Because detrusor contraction is nonlinear by urodynamic tests, it is difficult to record the changes in the detrusor length using traditional noninvasive methods. However, using topological principles, noninvasive urodynamics (NIUD) was successfully established. We assumed the bladder as a hollow sphere, we also assumed that a length of an elastic element equals the perimeter of a circle through the sphere center.

There are three basic principles for NIUD: One is that when the smooth muscle is at an optimal length, the greater the contractility the faster the contraction. The other is that the smooth muscle contraction is rhythmic, with alternating active and passive tensile forces. The last is that the changes in the length of the elastic element must obey the behavior of the detrusor myocytes. When using the C/Q nomogram to diagnose the bladder outflow obstruction (BOO) in male, we rule that the initial bladder volume (or the urine volume before the voiding) should be more than 150 ml for making sure the elastic element at an optimal initial length. Moreover, when the initial bladder volume (or the urine volume before the voiding) is over 300 ml, there seems to be with more consistency.

When using the C/Q nomogram to diagnose the BOO, only cases with RDCVV less than 0.2 during the whole voiding but except for the first three seconds and last three seconds are suitable, since the inventors of the present application have found that the abdominal pressure might influence the diagnosing results.

The foregoing descriptions are merely specific embodiments of the present invention, but are not intended to limit the protection scope of the present invention. Any variation or replacement readily figured out by persons skilled in the art within the technical scope disclosed in the present invention shall all fall within the protection scope of the present invention.

What is claimed is:

1. A noninvasive method for urodynamics testing and analysis, comprising:
modeling a bladder before a releasing of the urine as a topological sphere,
modeling a circle formed by cutting the topological sphere through its center as an elastic element,
determining a functional relation between a length L of the elastic element and a urine volume a within the bladder: L=F(a),
determining a functional relation between a length contraction ΔL of the elastic element and both of a urinary flow rate Q and the urine volume a within the bladder: ΔL=ξ(Q,a),
determining a functional relation between a contraction velocity ν of the elastic element and the length contraction ΔL of the elastic element: ν=ΔL,
calculating a value of an index DC for assessing a bladder contractility according to the following formula:
$$DC = \frac{{\sum }_{i = 1}^{n} ( Δ {t}_{i} - \overline{t} ) ( Δ {L}_{i} - Δ \overline{L} )}{{\sum }_{i = 1}^{n} {( Δ {t}_{i} - \overline{t} )}^{2}}$$
wherein,
n=5,
tᵢ=time point i,
Δtᵢ=tᵢ−tᵢ₋₁,
t̅=mean time=(t₁+t₂+ . . . +tₙ)/n,
ΔLᵢ=a length contraction ΔL of the elastic element at a time point i, and ΔLᵢ=Lᵢ₋₁−Lᵢ,
ΔL=mean length contraction ΔL of the elastic element=(ΔL₁+ΔL₂+ . . . +ΔLₙ)/n,
comparing the value of DC of a subject with normal values of DC to determine the bladder contractility of the subject,
determining that the bladder contractility of the subject is impaired and further investigations are required, if the value of DC of the subject is lower than the normal values, and
determining that the subject is diagnosed to have a normal bladder contractility, if the value of DC of the subject is within the range of the normal values.

2. The noninvasive method for urodynamics testing and analysis according to claim 1, characterized in that, the value of DC of the subject is compared with 1, if the value of DC of the subject is lower than 1, the bladder contractility of the subject is impaired; if the value of DC of the subject is greater or equal to 1, the bladder contractility of the subject is normal.

3. The noninvasive method for urodynamics testing and analysis according to claim 1, characterized in that, a noninvasive method for checking if there is a significant involvement of an abdominal pressure at a time point i during the releasing of the urine comprises:
calculating a value of an index RDCVV at a time point i according to the following formula:
$$RDCVV = \frac{Δ {L}_{i}}{Δ {L}_{i - 1}} - 1$$
wherein ΔLᵢ=the length contraction ΔL of the elastic element at a time point i, ΔLᵢ₋₁=the length contraction ΔL of the elastic element at a time point i−1, and ΔLᵢ=Lᵢ₋₁−Lᵢ,
comparing an absolute value |RDCVV| of the value of RDCVV with 0.2,
determining that the involvement of the abdominal pressure is significant at the time point i if the value of |RDCVV| is greater than 0.2, except for the first three seconds and the last three seconds during the releasing of the urine, and
determining that the involvement of the abdominal pressure is insignificant at the time point i if the value of |RDCVV| is lower than 0.2, except for the first three seconds and the last three seconds during the releasing of the urine.

4. The noninvasive method for urodynamics testing and analysis according to claim 1, characterized in that, a noninvasive method for diagnosing a bladder outflow obstruction in male comprises:
calculating values of DC and a maximum flow rate from a group of samples who have undergone cystometry to diagnose the bladder outflow obstruction,
obtaining the values of DC and the maximum flow rate for each of these samples,
drawing a scatter plot according to the values of DC and the maximum flow rate,
establishing a DC-Maximum Flow Rate nomogram as a standard according to results of the cystometry, with the DC-Maximum Flow Rate nomogram categorizing a void as obstructed, equivocal or unobstructed, and
diagnosing the bladder outflow obstruction of a subject by plotting his value of DC at maximum flow rate on the DC-Maximum Flow Rate nomogram.

5. The noninvasive method for urodynamics testing and analysis according to claim 4, characterized in that, the group of samples and the subject all have a an initial urine volume within the bladder greater than 150 ml, DC more than 1 and absolute values of RDCVV less than 0.2 throughout the releasing of the urine except for the first three seconds and last three seconds.

6. The noninvasive method for urodynamics testing and analysis according to claim 5, characterized in that, the initial urine volume within the bladder is greater than 300 ml.
